(19) United States
(12) Patent Application Publication
(10) Pub. No.: US 2025/0315558 A1
(43) Pub. Date: Oct. 9, 2025

(54) METHOD FOR PROTECTING A MICROCONTROLLER

(71) Applicant: STMicroelectronics International N.V., Geneva (CH)

(72) Inventors: Raphael CLAUSS, ST EGREVE (FR); Gerald BRIAT, Vif (FR); Chrislain DALLERY, LE GRAND LEMPS (FR); Paul BERTHON, Grenoble (FR)

(21) Appl. No.: 19/091,099

(22) Filed: Mar. 26, 2025

(30) Foreign Application Priority Data
Apr. 9, 2024 (FR) FR2403635

(51) Int. Cl. G06F 21/64; G06F 21/60

(52) U.S. Cl. CPC G06F 21/64; G06F 21/604

(57) ABSTRACT

A method of protecting a microcontroller is provided. An example method comprises a personalization phase and a boot phase. A personalization phase comprises: the calculation of a first checksum on the content of at least one configuration register of the microcontroller stored in a first memory, and the storage, into the first memory, of the first checksum; and the copying of the first checksum and of the register to a second memory. A boot phase comprises: the copying of the first checksum and of the register from the second memory to the first memory; and the comparison between a second checksum, calculated on the content of the copied register, and the copied first checksum.

### CROSS REFERENCE TO RELATED APPLICATION(S)

This application claims the priority benefit of French Patent Application Number FR2403635, filed on Apr. 9, 2024, entitled “Procédé de protection d'un microcontrôleur,” which is hereby incorporated by reference to the maximum extent allowable by law.

### TECHNICAL FIELD

The present disclosure generally concerns microcontroller protection methods and microcontrollers implementing such methods.

### BACKGROUND

Certain microcontrollers use configuration registers preloaded at the booting from a non-volatile memory and which may be updated. At the booting, these registers are accessible by different components of the microcontroller and enable to configure them.

### BRIEF SUMMARY

There exists a need to protect the microcontroller components against attacks targeting the registers, and particularly the configuration registers.

An embodiment overcomes all or part of the of the disadvantages of known methods.

An embodiment provides a method for protecting a microcontroller comprising,
in a personalization phase:
   the calculation of a first checksum on the content of at least one configuration register of the microcontroller stored in a first memory, and the storage, into the first memory, of the first checksum; and the copying of the first checksum and of the register to a second memory;
in a boot phase: the copying of the first checksum and of the register, from the second memory to the first memory; and the comparison between a second checksum, calculated on the content of the copied register, and the copied first checksum.

An embodiment provides a microcontroller comprising a first and a second memory, and configured to,
during a personalization phase: calculate a first checksum on the content of at least one configuration register of the microcontroller stored in the first memory and store, into the first memory, the first checksum; and copy the first checksum and the register to the second memory;
during a boot phase: copy the first checksum and the register, from the second memory to the first memory; and perform a comparison between a second checksum, calculated from the copied register, and the copied first checksum.

In an embodiment, when the first and the second checksums are different in the comparison, then the values of the copied register are modified.

In an embodiment, when the first and the second checksums are identical in the comparison, then the copied register is not modified.

In an embodiment, the configuration of the microcontroller, defined by the modified values of the register, corresponds to a maximum level of access restriction.

In an embodiment, the configuration of the microcontroller, defined by the modified values of the register, corresponds to a maximum level of addressing mode restriction.

In an embodiment, the configuration of the microcontroller, defined by the modified values of the register, corresponds to a maximum level of boot program access prohibition.

In an embodiment, the levels of boot program access prohibition correspond, for example, to levels of protection of successively-installed boot programs, the protection levels being implemented by using a monotonic counter.

In an embodiment, the configuration of the microcontroller, defined by the modified values of the register, comprises a microcontroller life cycle state corresponding to a mode (provisioning) where the content of the programs of the microcontroller is inaccessible.

In an embodiment, the second checksum is calculated periodically.

In an embodiment, the storage of the copied first checksum is performed in a register of the first memory.

In an embodiment, the first memory is a volatile memory.

In an embodiment, the second memory is a non-volatile memory.

In an embodiment, the first and the second checksums are based on cyclic redundancy calculations.

In an embodiment, the calculation of the first and second checksums as well as their comparison are implemented by a memory interface of the first memory or of the second memory.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an example of an integrated circuit of the type to which the described embodiments apply;

FIG. 2 schematically shows an operating method of the microcontroller of FIG. 1 according to an example;

FIG. 3 schematically shows an operating method of the microcontroller of FIG. 1 according to an embodiment;

FIG. 4 schematically shows a phase of an operating method of the microcontroller of FIG. 1 according to an embodiment; and

FIG. 5 schematically shows another phase of an operating method of the microcontroller of FIG. 1 according to an embodiment.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

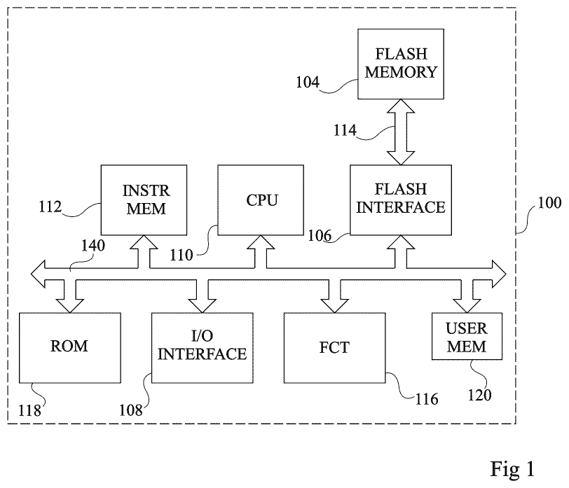

FIG. 1 shows, very schematically and in the form of blocks, an example of an integrated circuit 100 of the type to which the described embodiments apply. Circuit 100 is, for example, a microcontroller.

Circuit 100 comprises a non-volatile memory 104 (NVM), for example of the FLASH or of phase-change memory (PCM) type, capable of communicating, via a communication bus 114, with a non-volatile memory interface 106 (NVM INTERFACE) configured to write or read data into and from non-volatile memory 104 but also to perform operations on the data.

Circuit 100 further comprises, for example, a processing unit 110 (CPU) comprising one or a plurality of processors under control of instructions stored in an instruction memory 112 (INSTR MEM). Instruction memory 112 is, for example, a volatile random access memory (RAM). Processing unit 110 and memory 112 communicate, for example, via a system (data, address and control) bus 140. Non-volatile memory 104 is coupled to system bus 140 via non-volatile memory interface 106 and via bus 114. Device 100 further comprises an input/output interface 108 (I/O interface) coupled to system bus 140 to communicate with the outside.

Circuit 100 may integrate other circuits implementing other functions, for example IP (Intellectual Property core) electronic blocks, such as, for example, one or a plurality of volatile and/or non-volatile memories, or other processing units, symbolized by a block 116 (FCT) in FIG. 1. Among other circuits, circuit 100 comprises, for example, a read-only or static memory 118 (ROM).

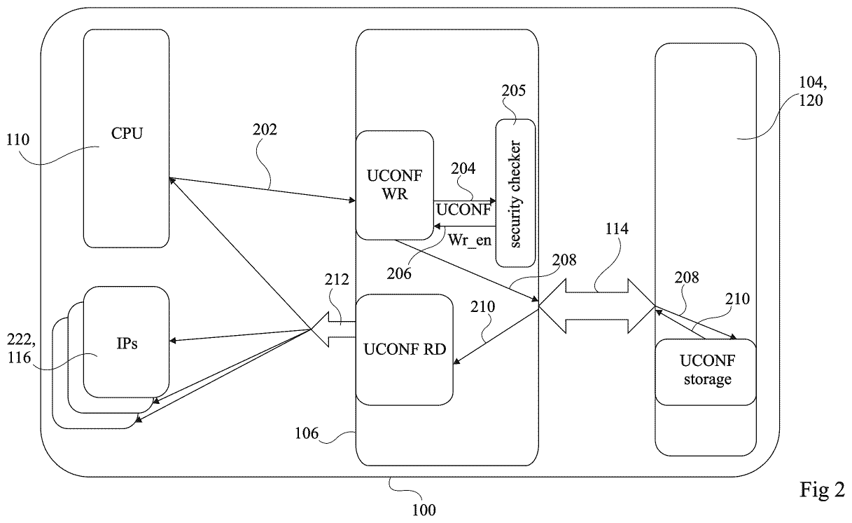

FIG. 2 schematically shows an operating method of the microcontroller 100 of FIG. 1 according to an example.

In the shown example, a personalization phase comprises successive steps 202, 204, 206, and 208.

At step 202 (UNCONF WR), processing unit 110 writes values into N registers called UCONF of a first memory. In the rest of the text, when reference is made to a register, this terms designates one or a plurality of configuration registers. These registers UCONF for example comprise security-related configuration information such as first and second access restriction levels, such as those implemented with the TrustZone protocol of the ARM® CORTEX-M architecture. Other examples of security-related configuration information for example comprise the definition of an application with a first privilege level (privileged, Priv) that gives more rights than a second privilege level (unpriviledged, unPriv). The first and second privilege levels are, for example, those implemented with an ARM® architecture. Thus, an application configured with the first privilege mode (Priv), that is, in a first addressing mode restriction mode, for example has its own space with physical addresses. An application implemented with the second privilege mode (unPriv), that is, in a second addressing mode restriction mode, for example has its own space with virtual addresses and cannot access other memory-related processes that would directly use physical addresses. Registers UCONF for example comprise other security-related configuration information such as information about the product state or life cycle, timing isolation level area information, addresses indicating where processing unit 110 is to start, or also security keys.

In an example, these N configuration registers UCONF are coded over 32 bits.

In another example, these registers are stored, when they are written by processing unit 110, into a first volatile memory.

At step 204, the values of the register are examined by a security checker (205) which is for example implemented by memory interface 106. Security checker 205 verifies, for example, whether the configurations stored in registers UCONF are legal.

If no problem is detected, then step 206 is implemented and security checker 205 generates one or a plurality of signals Wr_en which are, for example, coded over a plurality of bits to ensure the security of the information.

When signal Wr_en is generated, step 208 (UCONF storage) is implemented and registers UCONF are written into a non-volatile memory, for example memory 104 or 120, for example via a bus such as bus 114.

This personalization phase is for example carried out by a professional user such as a subcontractor or an integrator of microcontroller 100.

In a boot phase comprising successive steps 210 and 212, microprocessor 110 is rebooted.

At step 210, the registers stored in non-volatile memory 104 are read from and copied (UCONF RD) into a memory, for example volatile, for example the first memory.

At step 212, blocks 108, 116, or 118, blocks 222 (IPs) or unit 110 are configured by using the values of the copied configuration registers (UCONF RD). Blocks 222 are for example electronic intellectual property core blocks, IP.

During the copying of the values of the registers from the second memory, attacks or hackings may be implemented, to for example modify the values of the configuration register, or also to provide information useful for other subsequent types of hacking. These attacks may further open temporary entry points for malicious programs.

To decrease the impact or prevent these attacks, it is possible, for example, to copy, at step 208, twice the register values, or their inverse, to two or more different locations in step 208. This however requires using large chip sizes. It is also possible to use error correction codes. However, this solution only enables to correct two or three corrupt bits and requires an increase in the number of registers.

To overcome these disadvantages, the described embodiments provide a method of protecting microcontroller 100 comprising,
in a personalization phase:
   the calculation of a first checksum (checksum 1) on the content of at least one configuration register (UCONF WR) of the microcontroller stored in a first memory, and the storage, into the first memory, of the first checksum; and
   the copying of the first checksum and of the register (UCONF WR) into a second memory 104, 120;
in a boot phase:
   the copying of the first checksum, checksum 1, and of the register from the second memory to the first memory; and
   the comparison between a second checksum (Checksum 2), calculated on the content of the copied register (UCONF RD), and the copied first checksum.

An advantage of this method is that it enables to decrease manufacturing costs, while enabling a fast processing and while guaranteeing a high security level for the configuration registers. On the other hand, this method is compatible with cyclic redundancy codes of 8, 16, 32, or more bits.

When the first and second checksums are different in the comparison, which may correspond to an attack, then the copied register is modified so that its values correspond to a maximum security configuration. Functions 108, 116, 118, 222 are thus potentially reconfigured to be in maximum protection modes.

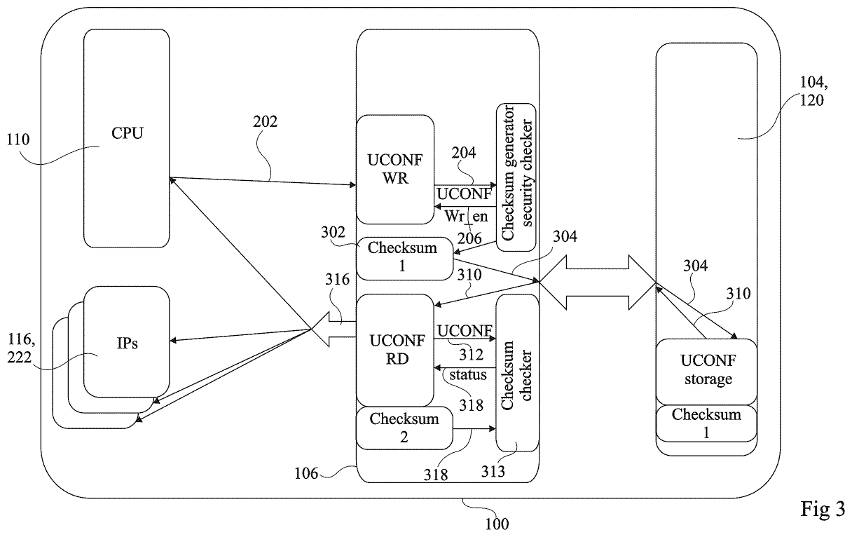

FIG. 3 schematically illustrates an operating method of the microcontroller of FIG. 1 according to an embodiment.

In the shown example, the personalization phase comprises steps 202, 204, and 206, which are identical to those of the example of FIG. 2, as well as successive steps 302 and 304.

At step 302, subsequent to step 206, once signal Wr_en has been generated, a first checksum 1 is calculated by a checksum generator, for example integrated in the control unit 205 of memory interface 106.

In an example, a checksum Checksum 1 is for example calculated for each of registers UCONF WR. There are thus potentially as many first checksums as configuration registers.

Generically, a checksum is the result of the execution of an algorithm, for example called cryptographic hash function, on a piece of data, in this case the values contained in a register. There exist many hash functions, such as MD5, SHA1, and SHA256.

In another example, the checksums are implemented with a cyclic redundancy check (CRC).

This is followed by step 304, in which the first checksum calculated for each register, as well as the associated registers (UCONF storage), are copied and then stored into the second memory 104, 120.

In a subsequent boot phase of the microcontroller and of its processing unit, in other words of microprocessor 110, the values of storage registers UCONF and the associated checksums copied to the second memory are copied, at a step 310, to a respective register UCONF_CRC_EXP of a memory, for example volatile, which is for example the first memory.

The first memory is for example part of block 116.

At a step 316, subsequent to step 310 and similar to step 212, the copied values of the registers (UCONF RD) may be used, for example, to configure blocks 108, 116, 118, 222 (IPs), and/or unit 110.

At a step 318, subsequent to step 316, a checksum checker 313, for example implemented by a memory interface such as memory interface 106 or by control unit 205, calculates a second checksum Checksum 2 for each copied register. In an example, control unit 205 and comparison unit 313 are a same circuit, for example formed in memory interface 106. Comparison unit 313 compares these second checksums, which have been calculated with the respective first checksums that have been copied and stored in the respective registers UCONF_CRC_EXP. According to the result of the comparison, the state of one or a plurality of so-called “status” signals, for example coded over a plurality of bits, indicates whether the comparison highlights a difference between the copied checksums and the recalculated checksums. In the case where the checksums are identical, then the values of registers UCONF RD remain unmodified. In the case where the first and second checksums are different in the comparison, then the values of the copied registers UCONF RD are modified, for example by control unit 205 or comparison unit 313, to take configuration values stricter in terms of access and security. This modification remains valid until the reboot next of microprocessor 110 or of microcontroller 100. Blocks 108, 116, 118, 222 (IPs) and/or processor 110 thus see their configuration modified to a configuration stricter in terms of access and/or security.

In an example of configuration stricter in terms of access and/or security, a configuration of microcontroller or of microprocessor 110, defined by the modified register(s) UCONF RD, comprises a maximum access restriction level corresponding, for example, to the “secure” mode of the TrustZone protocol of the ARM® architecture.

In another example, the configuration of microcontroller 100, or of microprocessor 110, defined by the modified register(s) UCONF RD, comprises a maximum level of addressing mode restriction (privileged).

In another example, the configuration of microcontroller 100, or of microprocessor 110, defined by the modified register(s) UCONF RD, comprises a maximum boot program access prohibition level (HDPL0). In this example, the boot program access prohibition levels (HDPL) correspond, for example, to protection levels of successively-installed boot programs, the protection levels being implemented by using a monotonic counter.

In another example, the configuration of microcontroller 100, or of microprocessor 110, defined by the modified register(s) UCONF RD, corresponds to a microcontroller life cycle state (product_state) corresponding to a mode (called provisioning) where the content of the microcontroller programs is inaccessible. In other words, in this state, not even the microcontroller manufacturer can access the content of the programs of the microcontroller or of microprocessor 110.

Step 318 may be carried out at each boot phase or after a plurality of reboots.

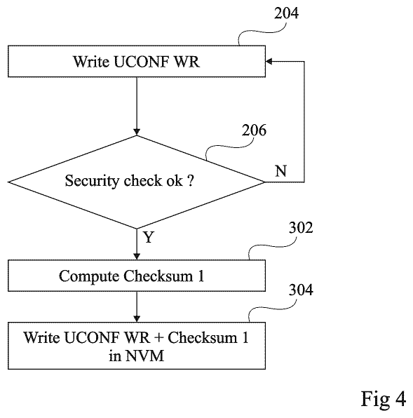

FIG. 4 schematically shows a phase of an operating method of the microcontroller of FIG. 1 according to an embodiment. In particular, the shown example illustrates the personalization phase.

The personalization phase of FIG. 4 comprises step 204 (Write UCONF WR), which is followed by step 206 (Security check ok?). If, during step 206, the control unit detects a fault (path “N”), then, for example, step 204 is resumed or an error is returned to processing unit 110. If during step 206, the processing unit detects no fault (path “Y”), then step 302 (Compute Checksum 1) is implemented.

Once the first checksum has been calculated, then step 304 (Write UCONF WR+Checksum 1 in NVM) is implemented and the values of registers UCONF WR as well as their respective first checksums are written into the second memory 104, 120.

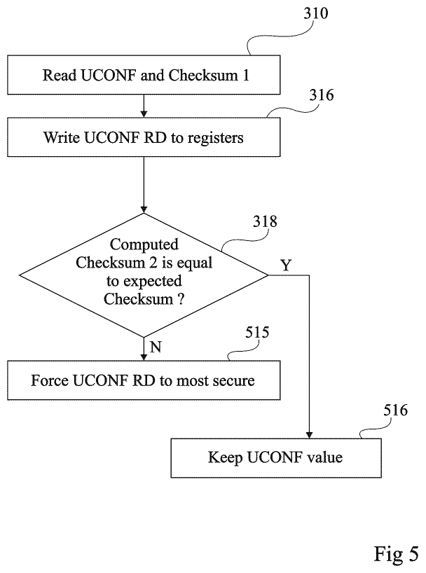

FIG. 5 schematically illustrates another phase of an operating method of the microcontroller of FIG. 1 according to an embodiment. More particularly, the example of FIG. 5 illustrates a boot phase.

In the shown example, after the booting of microcontroller 100 or of microprocessor 110, step 310 (Read UCONF and Checksum 1) is implemented. In this step, the values of the registers and the associated checksums stored in second memory 104, 120 are copied to the first memory, for example.

Step 316 (Write UCONF RD to registers) is then implemented. At this step, registers of the various blocks 108, 116, 118, 222 (IPs) and/or unit 110 are written with the respective values of the copied configuration registers UCONF RD.

Step 318 (Computed Checksum 2 is equal to expected Checksum?) is then implemented. If the calculated second checksums are equal to the respective first checksums which have been copied at step 310 (branch Y), then a step 516 (Keep UCONF value) is implemented. At this step 516, the values of configuration registers UCONF RD remain unmodified. If the calculated second checksums are different from the respective first checksums which have been copied to the respective registers UCONF_CRC_EXP at step 310 (branch N), then a step 515 (Force UCONF RD to most secure) is implemented. At this step 515, the values of the copied registers UCONF RD are modified, for example by control unit 205 or comparison unit 313, and replaced by the strictest configuration values in terms of access and of security. This modification remains valid until the next reboot of microprocessor 110 or of microcontroller 100. Blocks 108, 116, 118, 222 (IPs) and/or processor 110 then see their configuration modified to a configuration stricter in terms of access and/or of security, which enables to limit the effects of an attack.

Various embodiments and variants have been described. Those skilled in the art will understand that certain features of these various embodiments and variants may be combined, and other variants will occur to those skilled in the art. In particular, at step 515, the values of the copied registers UCONF RD may be modified and replaced with configuration values that are stricter in terms of access and of security, but not the strictest in terms of access and of security.

Finally, the practical implementation of the described embodiments and variants is within the abilities of those skilled in the art based on the functional indications given hereabove. In particular, the calculation of the second checksums may be performed at each boot cycle or after a plurality of boot cycles. Further, at each boot cycle, it will be possible, for example, to calculate the second checksum on the values of a single one or of a few only of the configuration registers.

In another example, step 318 may take place before step 316.

1. A method for protecting a microcontroller comprising:
in a personalization phase:
calculating a first checksum on a content of at least one configuration register of the microcontroller stored in a first memory, and storing, into the first memory, of the first checksum; and
copying the first checksum and the content of the at least one configuration register to a second memory;
in a boot phase:
copying of the first checksum and of the content of the at least one configuration register from the second memory to the first memory; and
comparing a second checksum, calculated on the content of the at least one configuration register copied from the second memory, and the first checksum copied from the second memory.

2. The method of claim 1, wherein, when the first checksum and the second checksum are different in the comparison, then one or more values of the content of the configuration register copied from the second memory are modified.

3. The method of claim 2, wherein, when the first checksum and the second checksum are identical in the comparison, then the content of the configuration register copied is not modified.

4. The method of claim 2, wherein a configuration of the microcontroller, defined by the one or more values modified of the content of the configuration register, corresponds to a maximum level of access restriction.

5. The method of claim 2, wherein a configuration of the microcontroller, defined by the one or more values modified of the content of the configuration register, corresponds to a maximum level of addressing mode restriction.

6. The method of claim 2, wherein a configuration of the microcontroller, defined by the one or more values modified of the content of the configuration register, corresponds to a maximum level of boot program access prohibition.

7. The method of claim 6, wherein one or more levels of boot program access prohibition correspond, to levels of protection of successively-installed boot programs, the levels of protection being implemented by using a monotonic counter.

8. The method of claim 2, wherein a configuration of the microcontroller, defined by the one or more values modified of the content of the configuration register, comprises a microcontroller life cycle state corresponding to a mode where one or more content of one or more programs of the microcontroller are inaccessible.

9. The method of claim 1, wherein the second checksum is calculated periodically.

10. The method of claim 1, wherein the copying of the first checksum is performed in a register of the first memory.

11. The method of claim 1, wherein the first memory is a volatile memory.

12. The method of claim 1, wherein the second memory is a non-volatile memory.

13. The method of claim 1, wherein the first checksum and the second checksum are based on cyclic redundancy calculations.

14. The method of claim 2, wherein calculating the first checksum and the second checksum as well as comparing the first checksum and the second checksum are implemented by a memory interface of the first memory or of the second memory.

15. The method of claim 1, wherein the first memory and the second memory are memories of the microcontroller.

16. A microcontroller comprising a first memory and a second memory, and wherein the microcontroller is configured to:
during a personalization phase:
calculate a first checksum on a content of at least one configuration register of the microcontroller stored in the first memory and store, into the first memory, the first checksum; and
copy the first checksum and the content of the at least one configuration register to the second memory;
in a boot phase:
copy the first checksum and the content of the at least one configuration register from the second memory to the first memory; and
compare a second checksum, calculated from the content of the at least one configuration register copied from the second memory, and the first checksum copied from the second memory.

17. The microcontroller of claim 16, wherein, when the first checksum and the second checksum are different in the comparison, then one or more values of the content of the configuration register copied are modified.

18. The microcontroller of claim 17, wherein, when the first checksum and the second checksum are identical in the comparison, then the content of the configuration register copied is not modified.

19. The microcontroller of claim 17, wherein a configuration of the microcontroller, defined by the one or more values modified of the content of the configuration register, corresponds to a maximum level of access restriction.

20. The microcontroller of claim 17, wherein a configuration of the microcontroller, defined by the one or more values modified of the content of the configuration register, corresponds to a maximum level of addressing mode restriction.
